(19) United States
(12) Patent Application Publication
(10) Pub. No.: US 2017/0240408 A1
(43) Pub. Date: Aug. 24, 2017

(54) KEG CLEANING SYSTEM AND METHOD

(71) Applicant: Scott Young, Purcellville, VA (US)

(72) Inventor: Scott Young, Purcellville, VA (US)

(21) Appl. No.: 15/050,861

(22) Filed: Feb. 23, 2016

(51) Int. Cl. B67D 1/07; B08B 9/08; B08B 5/02; B67D 1/08

(52) U.S. Cl. CPC B67D 1/07; B67D 1/0801; B08B 9/0813; B08B 5/02; B67D 2001/0822

(57) ABSTRACT

A keg cleaning system and method is provided. The keg cleaning system and method is operable to first pump a fluid cleaner through an intake of a keg coupler and into a keg at a high pressure. The liquid cleaner is pumped into the keg for a short period of time. After the liquid cleaner has been pumped into the keg, CO2 or air is then pumped through the intake of the keg coupler and into the keg at a high pressure for a short period of time. The liquid cleaner is then forced out of a keg coupler exhaust. The steps are repeated until the inside of the keg is clean. Due to the repeated surges from the pump and the surges from the air or CO2 the inside of the keg is thoroughly cleaned.

### BACKGROUND OF THE INVENTION

The present invention relates to kegs and, more particularly, to a keg cleaning system and method.

A keg is a small barrel. A keg is often constructed of aluminum or steel. It is commonly used to store, transport, and serve beer. Other alcoholic or non-alcoholic drinks, carbonated or non-carbonated, may be housed in a keg as well. Such liquids are generally kept under pressure. A keg has a single opening on one end, called a “bung.” A tube called a “spear” or “stem” extends from the opening to the other end. There is a self-closing valve that is opened by the coupling fitting which is attached when the keg is tapped. There is also an opening at the top of the spear that allows gas (usually carbon dioxide) to drive the beer out of the keg. The coupling fitting has one or two valves that control the flow of beer out of and gas into the keg. Thorough cleaning of the inside of a keg is difficult. When liquid is pushed into the keg for cleaning, the liquid cannot exit without air entering the keg. Air cannot exit the keg fast enough to allow for a thorough spraying of the inside of the keg. Removing unwanted materials that are attached to the inside of the keg is difficult because the inside of the keg is not directly accessible.

As can be seen, there is a need for an improved system and method of cleaning a keg.

### SUMMARY OF THE INVENTION

In one aspect of the present invention, a method of cleaning a keg comprises the steps of: pumping a fluid cleaner through an intake of a keg coupler and into a keg for a first period of time comprising at least 1 second and up to 30 seconds; ending the pumping of the fluid cleaner into the keg after the first period of time has expired; and spraying a pressurized gas through the intake of the keg coupler and into the keg for a second period of time comprising at least 1 second and up to 30 seconds after the fluid cleaner is no longer being pumped into the keg.

In another aspect of the present invention, a method of cleaning a keg comprises the steps of: providing a keg cleaner unit comprising: a first container comprising a pressurized gas; a second container comprising a fluid cleaner; a pump; a first fluid line running from the first container to the pump; a second fluid line running from the second container to the pump; a third fluid line running from the pump; a first valve coupled to the first fluid line; and a second valve coupled to the second fluid line; connecting the third fluid line to a keg coupler; opening the second valve; pumping the fluid cleaner into the keg via the pump for a first period of time comprising at least 1 second and up to 30 seconds; closing the second valve; opening the first valve; pumping the pressurized gas into the keg via the pump for a second period of time comprising at least 1 second and up to 30 seconds.

These and other features, aspects and advantages of the present invention will become better understood with reference to the following drawings, description and claims.

### BRIEF DESCRIPTION OF THE DRAWINGS

FIG. 1 is a schematic view of an embodiment of the present invention; and

FIG. 2 is a front elevation and partial sectional view taken along line 2-2 of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a surge method of cleaning a keg and thereby provides a greater force to dislodge anything that is stuck onto the inside of the keg. The present invention uses short surges of cleaner followed by short surge of CO2 or air sprayed inside of the keg. This allows for a greater pressure spraying force and does not allow air into the keg. The cleaner is then exhausted from the keg which prevents the keg from filling up with cleaner.

A pump turns on and off in timed intervals. First, the cleaner valve is opened which allows a cleaner to go through the pump spray within the keg at high pressure, which creates a surge. Instead of running the pump for a long time it is quickly shut off. A small amount of cleaner may remain within the lines. A timer then shuts off the pump and opens a CO2 or air valve. This forces the remaining cleaner into the keg at very high pressure creating another surge. The process is then repeated providing multiple surges into the keg.

The pressure of the pump and the pressure of the CO2 or air contribute directly to the length that the cleaner valve and the CO2 or air valve is opened. Given an adequate sized supply line and and exhaust from the keg, the gallons per minute (GPM) of input should equal to the GPM exhaust. GPM input is determined by pump manufacture rating. GPM exhaust is determined by CO2 or air pressure times 3. Therefore, timing to optimally achieve surge washing without filling up the keg is: Pump GPM=CO2 or air psi*3. Example: pump of 60 GPM will include 20 psi of CO2 applied over the same amount of time.

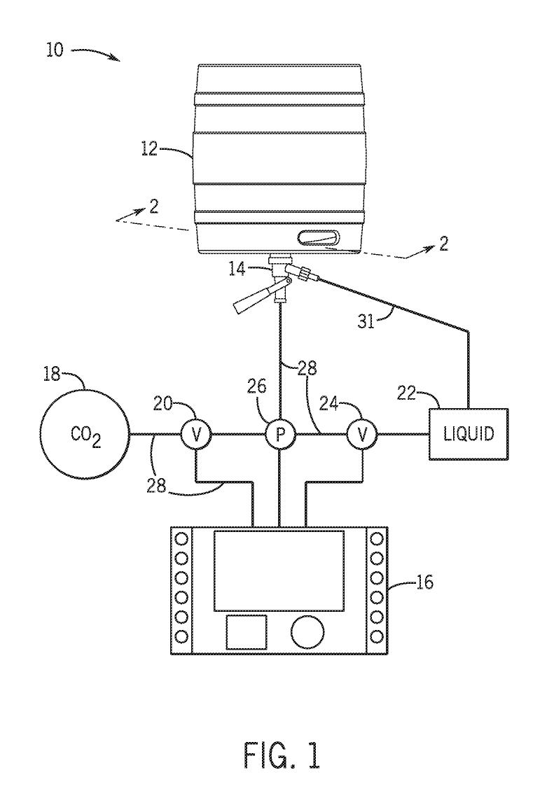

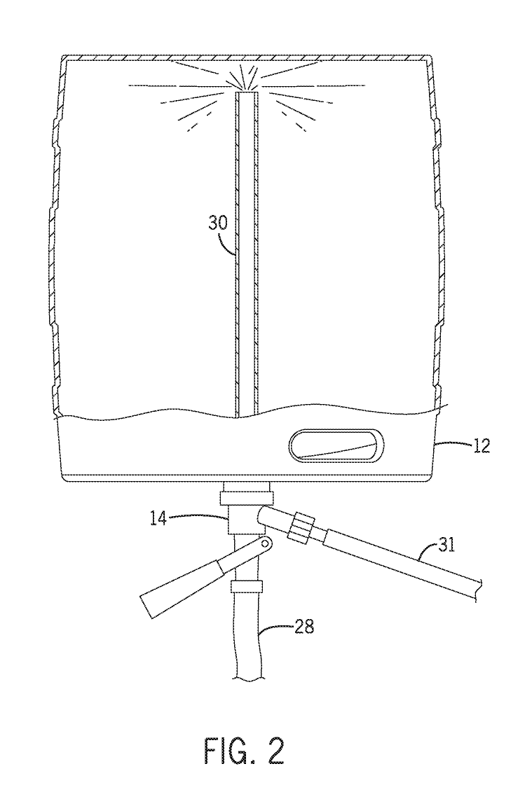

Referring to FIGS. 1 and 2, the present invention includes a keg cleaning system 10. The keg cleaning system 10 is operable to first pump a fluid cleaner through an intake of a keg coupler 14 and into a keg 12 at a high pressure. The liquid cleaner is pumped into the keg 12 for a first period of time. After the liquid cleaner has been pumped into the keg 12, a pressurized air is pumped through the intake of the keg coupler 14 and into the keg 12 at a high pressure for a second period of time. The liquid cleaner is then forced out of a keg coupler exhaust at higher pressure.

In certain embodiments, the first period of time may include at least 1 second and up to 30 seconds, at least 1 second up to and 15 seconds, or at least 1 second and up to 10 seconds. In certain embodiments, the second period of time may include at least 1 second and up to 30 seconds, at least 1 second up to and 15 seconds, or at least 1 second and up to 10 seconds. In certain embodiments, the liquid cleaner and the pressurized gas are pumped into the keg multiple times, one after the other, until the inside of the keg 12 is clean. The steps listed above, may be repeated from about 1 time up to about 10 times. Pumping the liquid cleaner and then the pressurized gas in short intervals creates multiple surges that dislodge any residue within the keg 12 until the keg is clean.

The keg cleaning system 10 of the present invention may include the following. A first container 18 includes the pressurized gas. The pressurized gas may include air, CO2 or other gasses. A second container 22 includes a fluid cleaner. A first fluid line 28 runs from the first container 18 to a pump 26 and a second fluid line 28 runs from the second container 22 to the pump 26. A third fluid line 28 runs from the pump 26 to the keg coupler 14. A first valve 20 is coupled to the first fluid line 28 and is operable to control a fluid flow of the first fluid line 28. A second valve 24 is coupled to the second fluid line 28 and is operable to control a fluid flow of the second fluid line 28.

To use the keg cleaning system 10 the following steps may be taken. The keg coupler 14 is first secured to a keg valve of a keg 12. The keg valve leads into the keg stem 30 within the keg 12. The third fluid line 28 is connected to the keg coupler 14, thereby connecting the pump 26 to the keg coupler 14. The second valve 24 is opened and the pump 26 is turned on, thereby pumping cleaning liquid into the keg 12 at a high pressure and creating a surge. The pumping of the cleaning liquid into the keg 12 is done for the first period of time. After the first period of time has expired, the second valve 24 is closed. The first valve 20 is then opened and the pressurized gas is pumped into the keg 10 at a high pressure for a second period of time, thereby initially creating a surge and pushing the fluid cleaner out of the keg 12. The steps are repeated sequentially until the keg 12 is clean.

In certain embodiments, the fluid cleaner may be recycled by pumping the fluid cleaner back into the second container 22. In such embodiments, the present invention may include a return fluid line 31. The return fluid line 31 connects to a keg coupler exhaust of the keg coupler 14 and runs to the second container 22. Therefore, when the pressurized gas is pumped into the keg 12, the fluid cleaner is pushed out of the keg coupler exhaust into the return fluid line 31 and back to the second container 22.

The present invention may further include a remote control 16 operable to open and close the first valve 20 and the second valve 24. In such embodiments, the remote control 16 may be wirelessly connected to the first valve 20 and the second valve 24. In certain embodiments, the remote control 16 may include a timer that is preprogrammed for each of the first valve 20 and the second valve 24 with the first and second periods of time. Therefore, a user may simply connect the fluid lines 28 and then press a wash command on the remote 16. The remote 16 then opens and closes the valves 20, 24 accordingly, and the keg 12 is properly washed.

It should be understood, of course, that the foregoing relates to exemplary embodiments of the invention and that modifications may be made without departing from the spirit and scope of the invention as set forth in the following claims.

1. A method of cleaning a keg comprising the steps of:
pumping a fluid cleaner through an intake of a keg coupler and into a keg for a first period of time comprising at least 1 second;
ending the pumping of the fluid cleaner into the keg after the first period of time has expired; and
spraying a pressurized gas through the intake of the keg coupler and into the keg after the fluid cleaner is no longer being pumped into the keg, wherein the pressurized gas is sprayed into the keg for a second period of time comprising at least 1 second, wherein
the fluid cleaner exits the keg when the pressurized gas is pumped into the keg.

2. The method of claim 1, wherein the fluid cleaner exits a keg coupler exhaust when the pressurized gas is pumped into the keg.

3. The method of claim 1, wherein the first period of time and the second period of time each comprise at least 1 second up to and 15 seconds.

4. The method of claim 1, wherein the first period of time and the second period of time each comprise at least 1 second and up to 10 seconds.

5. The method of claim 1, further comprising the step of: repeating the steps of claim 1 until an inside of the keg is clean.

6. The method of claim 1, wherein the pressurized gas comprises one of air and CO2.

7. A method of cleaning a keg comprising the steps of:
providing a keg cleaner unit comprising:
a first container comprising a pressurized gas;
a second container comprising a fluid cleaner;
a pump;
a first fluid line running from the first container to the pump;
a second fluid line running from the second container to the pump;
a third fluid line running from the pump;
a first valve coupled to the first fluid line; and
a second valve coupled to the second fluid line;
connecting the third fluid line to a keg coupler;
opening the second valve;
pumping the fluid cleaner into the keg via the pump for a first period of time comprising at least 1 second;
closing the second valve;
opening the first valve;
pumping the pressurized gas into the keg via the pump for a second period of time comprising at least 1 second.

8. The method of claim 7, further comprising the step of: connecting a return fluid line to a keg coupler exhaust and the second container, wherein the fluid cleaner is exhausted through the return fluid line during the step of pumping the pressurized gas into the keg.

9. The method of claim 7, further comprising the step of: providing a remote control wirelessly connected to the first valve and the second valve and operable to close and open the first valve and the second valve.

10. The method of claim 9, wherein the remote control comprises a preprogrammed timer set for each of the first valve and the second valve.

11. The method of claim 7, wherein the first period of time and the second period of time each comprise at least 1 second and up to 15 seconds.

12. The method of claim 7, wherein the first period of time and the second period of time each comprise at least 1 second and up to 10 seconds.

13. The method of claim 7, further comprising the step of: repeating the steps of claim 7 until an inside of the keg is clean.

14. The method of claim 7, wherein the pressurized gas comprises one of air and CO2.
